(19) United States
(12) Patent Application Publication
(10) Pub. No.: US 2023/0323137 A1
(43) Pub. Date: Oct. 12, 2023

(54) COMPOSITION FOR SEALING COATED ELECTRIC WIRE, AND COATED ELECTRIC WIRE

(71) Applicant: TOAGOSEI CO., LTD., Minato-ku, Tokyo (JP)

(72) Inventor: Akira TAKAGI, Nagoya-shi, Aichi (JP)

(21) Appl. No.: 18/004,453

(22) PCT Filed: Jul. 7, 2021
(86) PCT No.: PCT/JP2021/025678

§ 371 Date: Jan. 6, 2023

(30) Foreign Application Priority Data
Jul. 10, 2020 (JP) 2020-119517

(51) Int. Cl. H01B 7/285; C09D 5/34; C09D 7/43

(52) U.S. Cl. CPC C09D 5/34; C09D 7/43; H01B 7/285

(57) ABSTRACT

A composition for sealing coated electric wire includes a 2-cyanoacrylate compound containing an alkyl-2-cyanoacrylate having an alkyl group with ≥ 2 carbon atoms, and a 2-cyanoacrylate having an ether bond in an ester residue (≥ 10 mass% relative to 100 mass% of the total of the 2-cyanoacrylate compound),and a thickener, and exhibiting a suction length of 7-42 mm when a tip of a capillary tube (120 mm length and an inner diameter of 1.05 mm) is immersed in a bath solution of 30 mm in depth of the composition for 2 seconds and pulled up, and then the capillary tube is left to stand for 24 hours wherein the capillary tube is placed so that a longitudinal direction of the capillary tube is horizontal with respect to a gravity direction. A sealed coated electric wire is provided. Excellent heat resistance, moisture heat resistance, and thermal shock resistance exhibited upon curing.

### TECHNICAL FIELD

The present invention relates to a composition for sealing a coated electric wire, containing a cyanoacrylate compound, and a coated electric wire. More particularly, the present invention relates to a composition widely utilized as a sealing agent for coated electric wires in the wiring of the various types of electrical systems of automobiles, home electric appliances, office automation (OA) equipment and the like, and various types of outdoor and indoor wiring, and also relates to a coated electric wire covered by the composition.

### BACKGROUND ART

In automobiles, home electric appliances, OA equipment and the like, various types of electrical systems are wired by electric wires, and for their wiring, coated electric wires are used. For the coated electric wires, there have been cases where gas and moisture enter the gap between the conducting wire and the coating, the conducting wire itself breaks due to corrosion, and further a precision component coupled to the electric wire is deteriorated to cause the malfunction of the equipment.

In order to avoid these troubles, conventionally, a method is adopted in which a composition for sealing a coated electric wire is provided in the boundary portion between the coated portion of a coated electric wire and the exposed portion of the conducting wire to fill and fix the gap to enhance airtightness. As such a composition for sealing a coated electric wire, one described in Patent Literature 1 or 2 is already known.

Patent Literature 1 describes a composition for sealing a coated electric wire, including an alkyl-2-cyanoacrylate, a 2-cyanoacrylate having an ether bond in the ester residue, and a (meth)acrylate having two or more (meth)acryloyloxy groups.

Patent Literature 2 describes a composition for sealing a coated electric wire, containing a 2-cyanoacrylate including 10 mass% or more of an alkyl-2-cyanoacrylate having an alkyl group with 4 or more carbon atoms in the main chain.

### CITATION LIST

### Patent Literature

Patent Literature 1: Japanese Pat. Laid-Open No. 9-118839
Patent Literature 2: International Publication No. WO 2018/216737

### SUMMARY OF INVENTION

It is an object of the present invention to provide a composition for sealing a coated electric wire which gives a cured product excellent in heat resistance, moisture heat resistance, and thermal shock resistance, and a coated electric wire covered by the composition.

According to one aspect of the present invention, the present invention provides a composition for sealing a coated electric wire, which comprises a 2-cyanoacrylate compound comprising an alkyl-2-cyanoacrylate having an alkyl group with 2 or more carbon atoms, and a 2-cyanoacrylate having an ether bond in an ester residue thereof, and a thickener,
wherein the composition includes 10 mass% or more of the 2-cyanoacrylate having an ether bond in an ester residue thereof relative to 100 mass% of the total of the 2-cyanoacrylate compound,
said composition exhibiting a suction length of not less than 7 mm to not more than 42 mm when a tip of a capillary tube having an inner diameter of 1.05 mm and a length of 120 mm is immersed in a bath solution of 30 mm in depth of the composition for sealing a coated electric wire for 2 seconds and pulled up, and then the capillary tube is left to stand for 24 hours in a state in which the capillary tube is placed so that a longitudinal direction of the capillary tube is horizontal with respect to a gravity direction.

According to an embodiment of the present invention, a viscosity of the composition of the present invention at 25° C. is 12 to 120 mPa·s.

According to another embodiment of the present invention, a content of the thickener is 0.1 parts by mass to 23 parts by mass relative to 100 parts by mass of the total of the 2-cyanoacrylate compound.

According to still another embodiment of the present invention, the thickener is a copolymer comprising a constituent unit derived from a (meth)acrylic monomer.

According to still another embodiment of the present invention, the thickener is an elastomer.

According to still another embodiment of the present invention, a weight average molecular weight of the thickener is 50000 or more.

According to still another embodiment of the present invention, the alkyl-2-cyanoacrylate having an alkyl group with 2 or more carbon atoms is at least one selected from a group consisting of ethyl-2-cyanoacrylate, n-propyl-2-cyanoacrylate, isopropyl-2-cyanoacrylate, n-butyl-2-cyanoacrylate, sec-butyl-2-cyanoacrylate, isobutyl-2-cyanoacrylate, and n-hexyl-2-cyanoacrylate.

According to still another embodiment of the present invention, a blending proportion of the alkyl-2-cyanoacrylate having an alkyl group with 2 or more carbon atoms is not less than 10 mass% to not more than 90 mass% relative to 100 mass% of the total of the 2-cyanoacrylate compound.

According to still another embodiment of the present invention, the thickener is a copolymer including at least a constituent unit derived from at least one monomer selected from a group consisting of ethylene, propylene, isoprene and butadiene, and a constituent unit derived from a (meth)acrylate.

According to still another embodiment of the present invention, the thickener is a copolymer including at least a constituent unit derived from at least one monomer selected from a group consisting of ethylene, propylene, isoprene and butadiene, a constituent unit derived from a (meth)acrylate, and a constituent unit derived from a monomer having a carboxy group.

According to still another embodiment of the present invention, the composition of the present invention comprises 0 to 50 mass% of a (meth)acrylate having two or more (meth)acryloyloxy groups in one molecule relative to 100 mass% of the total of the composition.

According to still another embodiment of the present invention, the composition of the present invention further comprises a phthalic anhydride derivative represented by the following general formula (1):

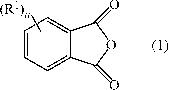

wherein R¹ is each independently an alkyl group, an acyl group, an acyloxy group, an aryloxycarbonyl group, an aryl group, a hydroxy group, a chlorine atom, a bromine atom, or an iodine atom, and n is an integer of 1 to 4.

According to still another embodiment of the present invention, the composition of the present invention further comprises a plasticizer.

According to still another embodiment of the present invention, in the composition of the present invention, a content of the plasticizer is 1 to 10 parts by mass relative to 100 parts by mass of the total of the 2-cyanoacrylate compound.

According to another aspect, the present invention provides a coated electric wire including a cured product of the composition for sealing a coated electric wire according to the present invention.

According to still another aspect, the present invention provides a method for making a sealed coated electric wire, including coating an exposed portion of a coated electric wire and a periphery thereof with the composition for sealing a coated electric wire according to the present invention, and curing the composition.

According to the present invention, there are provided a composition for sealing a coated electric wire which gives a cured product excellent in heat resistance, moisture heat resistance, and thermal shock resistance, and a coated electric wire comprising the cured product of the composition for sealing a coated electric wire.

### DESCRIPTION OF EMBODIMENTS

Embodiments of the present invention will be described below, but the present invention is not limited to these.

As used herein, “(meth)acryl” means both or either one of acryl and methacryl, “(meth)acryloyl” means both or either one of acryloyl and methacryloyl, and “(meth)acrylate” means both or either one of acrylate and methacrylate.

### 1. 2-Cyanoacrylate Compound

A composition for sealing a coated electric wire according to the present invention contains a 2-cyanoacrylate compound as the main adhesive component.

The composition for sealing a coated electric wire according to the present invention contains, as the 2-cyanoacrylate compound, an alkyl-2-cyanoacrylate having an alkyl group having 2 or more carbon atoms, and a 2-cyanoacrylate having an ether bond in the ester residue, as essential components.

### 1-1. Alkyl-2-Cyanoacrylate Having Alkyl Group Having 2 or More Carbon Atoms

For the alkyl-2-cyanoacrylate having an alkyl group having 2 or more carbon atoms, various ones can be used. The upper limit of the number of carbon atoms is not particularly limited and can be, for example, 12 or less, and is preferably 7 or less. Specific examples include ethyl-2-cyanoacrylate, n-propyl-2-cyanoacrylate, isopropyl-2-cyanoacrylate, n-butyl-2-cyanoacrylate, 2-butyl-2-cyanoacrylate, isobutyl-2-cyanoacrylate (2-methylpropyl-2-cyanoacrylate), n-hexyl-2-cyanoacrylate, n-heptyl-2-cyanoacrylate, 1-methylpentyl-2-cyanoacrylate, n-octyl-2-cyanoacrylate, 2-octyl-2-cyanoacrylate, 2-ethylhexyl-2-cyanoacrylate, n-nonyl-2-cyanoacrylate, isononyl-2-cyanoacrylate, n-decyl-2-cyanoacrylate, isodecyl-2-cyanoacrylate, n-undecyl-2-cyanoacrylate, and n-dodecyl-2-cyanoacrylate. One of these may be used alone, or two or more of these can also be used in combination.

Among these, alkyl-2-cyanoacrylates having an alkyl group having 2 to 6 carbon atoms are preferred, and specific examples thereof include at least one compound selected from the group consisting of ethyl-2-cyanoacrylate, n-propyl-2-cyanoacrylate, isopropyl-2-cyanoacrylate, n-butyl-2-cyanoacrylate, sec-butyl-2-cyanoacrylate, isobutyl-2-cyanoacrylate, and n-hexyl-2-cyanoacrylate. An alkyl-2-cyanoacrylate having an alkyl group having 2 to 6 carbon atoms is preferably included because the heat resistance of the obtained cured product is good.

The content of the alkyl-2-cyanoacrylate having an alkyl group having 2 or more carbon atoms is preferably 10 mass% or more and 90 mass% or less with respect to 100 mass% in total of the 2-cyanoacrylate compound, and preferably 30 mass% to 70 mass% from the viewpoint of the moisture heat resistance of the obtained cured product.

### 1-2. 2-Cyanoacrylate Having Ether Bond in Ester Residue

Examples of the 2-cyanoacrylate having an ether bond in the ester residue include alkoxyalkyl-2-cyanoacrylates and 2-cyanoacrylates of cyclic alkyl ethers.

In the present invention, the “ester residue” is the moiety in the compound other than the ester bond, that is, the moiety represented by -R of the group represented by -CO-O-R ester-bonded to the 2-cyanoacrylate.

As the alkoxyalkyl-2-cyanoacrylates, those in which the number of carbon atoms of the alkoxyalkyl group is 2 to 12 are preferred, those in which the number of carbon atoms of the alkoxyalkyl group is 2 to 10 are more preferred, and those in which the number of carbon atoms of the alkoxyalkyl group is 2 to 8 are still more preferred. Specific examples of the alkoxyalkyl-2-cyanoacrylates include methoxyethyl-2-cyanoacrylate, ethoxyethyl-2-cyanoacrylate, propoxyethyl-2-cyanoacrylate, isopropoxyethyl-2-cyanoacrylate, butoxyethyl-2-cyanoacrylate, hexyloxyethyl-2-cyanoacrylate, 2-ethylhexyloxyethyl-2-cyanoacrylate, butoxyethoxyethyl-2-cyanoacrylate, hexyloxyethoxyethyl-2-cyanoacrylate, 2-ethylhexyloxyethoxyethyl-2-cyanoacrylate, methoxypropyl-2-cyanoacrylate, methoxypropoxypropyl-2-cyanoacrylate, methoxypropoxypropoxypropyl-2-cyanoacrylate, ethoxypropyl-2-cyanoacrylate, and ethoxypropoxypropyl-2-cyanoacrylate.

Specific examples of the 2-cyanoacrylates of cyclic alkyl ethers include tetrahydrofurfuryl-2-cyanoacrylate.

One 2-cyanoacrylate having an ether bond in the ester residue may be used alone, or two or more 2-cyanoacrylates having an ether bond in the ester residue may be used in combination.

Among these, alkoxyethyl-2-cyanoacrylates in which the number of carbon atoms of the alkoxy group is 1 to 8, such as methoxyethyl-2-cyanoacrylate, ethoxyethyl-2-cyanoacrylate, and butoxyethyl-2-cyanoacrylate, are preferably used because of easy availability and excellent stability, and ethoxyethyl-2-cyanoacrylate is particularly preferred.

In the composition for sealing a coated electric wire according to the present invention, the content of the 2-cyanoacrylate having an ether bond in the ester residue is 10 mass% or more, preferably 20 mass% or more and 95 mass% or less, and more preferably in the range of 30 mass% or more and 90 mass% or less, with the total of the 2-cyanoacrylate compound being 100 mass%. When the content of the 2-cyanoacrylate having an ether bond in the ester residue is 10 mass% or more, the heat resistance, the moisture heat resistance, and the thermal shock resistance are good.

For a preferred configuration of the 2-cyanoacrylate compound in the composition of the present invention, the 2-cyanoacrylate compound includes 10 mass% to 90 mass% of the 2-cyanoacrylate having an ether bond in the ester residue, and 10 to 90 mass% of the alkyl-2-cyanoacrylate having an alkyl group having 2 or more carbon atoms, with respect to 100 mass% in total of the 2-cyanoacrylate compound and may include 10 to 30 mass% of another 2-cyanoacrylate compound as needed.

The content of the entire 2-cyanoacrylate compound in the composition for sealing a coated electric wire according to the present invention is preferably 50 mass% or more, more preferably 60 mass% to 99.9 mass%, and further preferably 65 mass% to 98 mass% with respect to the total mass of the composition for sealing a coated electric wire, from the viewpoint of keeping the heat resistance, moisture heat resistance, and thermal shock resistance of the cured product good without impairing the curing rate.

### 2. Thickener

The composition for sealing a coated electric wire according to the present invention includes a thickener.

The thickener is not particularly limited as long as it exhibits a thickening effect. Examples of the thickener include homocopolymers or copolymers including a constituent unit derived from a (meth)acrylic monomer, cellulose derivatives such as hydroxypropyl cellulose and cellulose acetate butyrate, acrylic rubber such as polybutyl acrylate, olefin-acrylic rubber such as ethylene-acrylic elastomers, acrylonitrile butadiene rubber (NBR), and butadiene rubber (BR), and in addition, various types of elastomers.

The thickener preferably has no polar groups such as a hydroxy group and an amino group.

The weight average molecular weight (Mw) of the thickener is preferably 10000 or more, more preferably 50000 or more, further preferably 100000 or more and 1000000 or less, and particularly preferably 150000 or more and 500000 or less from the viewpoint of the moisture heat resistance and thermal shock resistance, heat resistance, and bending resistance of the obtained cured product.

As the thickener, from the viewpoint of the moisture heat resistance and thermal shock resistance, heat resistance, and bending resistance of the obtained cured product, at least one compound selected from the group consisting of olefin-acrylic rubber, acrylonitrile butadiene rubber (NBR), cellulose derivatives, acrylic rubber, and butadiene rubber (BR) is preferred, at least one compound selected from the group consisting of olefin-acrylic rubber and acrylonitrile butadiene rubber (NBR) is more preferred, olefin-acrylic rubber is further preferred, and ethylene-acrylic elastomers are particularly preferred.

The thickener is preferably a homocopolymer or copolymer including a constituent unit derived from a (meth)acrylic monomer, from the viewpoint of the moisture heat resistance and thermal shock resistance, and heat resistance of the obtained cured product.

Examples of the (meth)acrylic monomer include (meth)acrylates, (meth)acrylonitrile, (meth)acrylic acid, and (meth)acrylamide. Specific examples thereof preferably include the (meth)acrylic monomers used for the elastomer described later.

Among them, as the (meth)acrylic monomer, (meth)acrylates are preferred, and alkyl (meth)acrylates are more preferred.

Examples of the homocopolymer or copolymer including a constituent unit derived from an alkyl (meth)acrylate include polymethyl (meth)acrylate, polybutyl (meth)acrylate, copolymers of methyl methacrylate and methyl acrylate, and copolymers of methyl methacrylate and ethyl acrylate.

The thickener is preferably an elastomer from the viewpoint of the moisture heat resistance and thermal shock resistance, heat resistance, and bending resistance of the obtained cured product.

The “elastomer” in the present invention is not particularly limited as long as it has rubber-like elasticity around ordinary temperature (20° C. ± 15° C.), or the peak of the loss tangent (tan δ) of the dynamic viscoelasticity measured at a frequency of 1 Hz is at 20° C. or less.

Examples of the elastomer having rubber-like elasticity around ordinary temperature include acrylate-based copolymers, acrylonitrile-styrene-based copolymers, acrylonitrile-styrene-acrylate-based copolymers, acrylonitrile-butadiene-based copolymers, acrylonitrile-butadiene-styrene-based copolymers, styrene-butadiene-based copolymers, styrene-isoprene-based copolymers, ethylene-acrylate-based copolymers, ethylene-propylene-based copolymers, ethylene-vinyl acetate-based copolymers, polyurethane-based copolymers, polyester-based copolymers, fluorine-based copolymers, polyisoprene-based copolymers, and chloroprene-based copolymers. One of these may be used alone, or two or more of these may be used in combination.

As the elastomer in which the peak of the loss tangent (tan δ) of the dynamic viscoelasticity measured at a frequency of 1 Hz is at 20° C. or less, a core-shell type elastomer can also be used.

In the core-shell type elastomer, the glass transition points (Tg) of the polymers constituting the core and/or the shell are preferably 20° C. or less, more preferably -10° C. or less.

Examples of the monomer of the core phase forming such a polymer include acrylates, and acrylates having an alkyl group having 2 to 8 carbon atoms are preferred.

On the other hand, the shell phase forming the outermost layer is not particularly limited as long as it is a polymer component easily compatible or dispersible with the 2-cyanoacrylate compound. But a glassy polymer having a glass transition point of 60° C. or more is preferably formed in the outermost layer.

Examples of the monomer forming the glassy polymer include methyl methacrylate and styrene.

Examples of preferred elastomers include copolymers including a constituent unit derived from a first monomer whose homopolymer can be a polymer poorly soluble in the 2-cyanoacrylate compound, and a constituent unit derived from a second monomer whose homopolymer can be a polymer soluble in the 2-cyanoacrylate compound (but excluding the following carboxy group-containing monomer). These copolymers preferably include a poorly soluble segment obtained by the polymerization of the first monomer, and a soluble segment obtained by the polymerization of the second monomer. The poorly soluble polymer means one having low solubility in the 2-cyanoacrylate compound, compared with the soluble polymer, and similarly, the poorly soluble segment means one having low solubility in the 2-cyanoacrylate compound, compared with the soluble segment.

The first monomer is not particularly limited, and examples thereof include ethylene, propylene, isoprene, butadiene, chloroprene, 1-hexene, and cyclopentene. One only of these monomers may be used, or two or more of these monomers may be used in combination.

The first monomer is preferably at least one monomer selected from the group consisting of ethylene, propylene, isoprene, butadiene, and chloroprene, more preferably at least one monomer selected from the group consisting of ethylene, propylene, isoprene, and butadiene.

The second monomer is not particularly limited either, and examples thereof include acrylates, methacrylates, vinyl chloride, vinyl acetate, vinyl ether, styrene, and acrylonitrile. The second monomer is preferably at least one monomer selected from the group consisting of acrylates and methacrylates.

Examples of the acrylates include methyl acrylate, ethyl acrylate, n-propyl acrylate, i-propyl acrylate, n-butyl acrylate, i-butyl acrylate, n-hexyl acrylate, n-heptyl acrylate, n-octyl acrylate, 2-ethylhexyl acrylate, methoxyethyl acrylate, methoxypropyl acrylate, ethoxyethyl acrylate, and ethoxypropyl acrylate. One only of these monomers may be used, or two or more of these monomers may be used in combination.

Further, examples of the methacrylates include methyl methacrylate, ethyl methacrylate, n-propyl methacrylate, i-propyl methacrylate, n-butyl methacrylate, i-butyl methacrylate, n-hexyl methacrylate, n-heptyl methacrylate, n-octyl methacrylate, 2-ethylhexyl methacrylate, methoxyethyl methacrylate, methoxypropyl methacrylate, ethoxyethyl methacrylate, and ethoxypropyl methacrylate. One only of these monomers may be used, or two or more of these monomers may be used in combination. An acrylate and a methacrylate may be used in combination.

The proportion between the poorly soluble segment obtained by the polymerization of the first monomer and the soluble segment obtained by the polymerization of the second monomer is not particularly limited. When the total of the monomer units forming these segments is 100 mol %, the amount of the monomer unit forming the poorly soluble segment is preferably 5 mol % to 90 mol %, more preferably 10 mol % to 80 mol %, further preferably 30 mol % to 80 mol %, particularly preferably 40 mol % to 80 mol %, and most preferably 50 mol % to 75 mol %, and the amount of the monomer unit forming the soluble segment is preferably 10 mol % to 95 mol %, more preferably 20 mol % to 90 mol %, further preferably 20 mol % to 70 mol %, particularly preferably 20 mol % to 60 mol %, and most preferably 25 mol % to 50 mol %. When the amounts of the monomer units are in the ranges, the copolymer can be moderately dissolved in the 2-cyanoacrylate compound, and a composition having high shear adhesion strength and the like and excellent durability together can be formed.

The proportion of each segment can be calculated by the integral value of the proton by proton nuclear magnetic resonance spectroscopy (hereinafter described as “1H-NMR”) measurement.

Further, examples of particularly preferred elastomers among the above elastomers also include copolymers obtained by copolymerizing the first monomer, the second monomer, and a monomer having a carboxy group (hereinafter also referred to as a “third monomer”). In these copolymers, the third monomer should be copolymerized in a small amount.

The third monomer is not particularly limited either, and examples thereof include acrylic acid, methacrylic acid, maleic acid, fumaric acid, itaconic acid, crotonic acid, and cinnamic acid. One only of these monomers may be used, or two or more of these monomers may be used in combination.

Examples of the third monomer preferably include acrylic acid and methacrylic acid, and either one of these may be used, or these may be used in combination.

The segment having a carboxy group obtained by the copolymerization of the third monomer is a segment soluble in the 2-cyanoacrylate compound having high hydrophilicity. When the elastomer is a copolymer having a carboxy group, a composition exhibiting better adhesion durability is provided.

The proportion of the segment having a carboxy group is not particularly limited either. But when the total of the monomer units forming the poorly soluble segment, the soluble segment, and the segment having a carboxy group is 100 mol %, the amount of the monomer unit forming the segment having a carboxy group is preferably 0.1 mol % to 5 mol %, more preferably 0.3 mol % to 4 mol %, further preferably 0.4 mol % to 3 mol %, particularly preferably 0.5 mol % to 2.5 mol %, and most preferably 0.5 mol % to 2.3 mol %. When the amount of the monomer unit is in the range, the curability is excellent, and the obtained cured product has excellent hot water resistance.

The proportion of the segment having a carboxy group can be measured by a potentiometric titration method or an indicator titration method according to JIS K0070 (1992).

As these copolymers, for example, ethylene/methyl acrylate copolymers, ethylene/methyl acrylate/butyl acrylate copolymers, ethylene/methyl methacrylate copolymers, ethylene/vinyl acetate copolymers, butadiene/methyl acrylate copolymers, butadiene/acrylonitrile copolymers, butadiene/acrylonitrile/acrylate copolymers, and butadiene/styrene/acrylonitrile/methyl acrylate copolymers can be used. Among them, ethylene/methyl acrylate copolymers or ethylene/methyl acrylate/butyl acrylate copolymers are particularly preferred.

For copolymers obtained by polymerizing the monomers used for the above copolymers, and a monomer having a carboxy group, such as acrylic acid and/or methacrylic acid, for example, ethylene/methyl acrylate/acrylic acid copolymers, ethylene/methyl acrylate/methacrylic acid copolymers, ethylene/methyl acrylate/butyl acrylate/acrylic acid copolymers, and ethylene/methyl acrylate/butyl acrylate/methacrylic acid copolymers can also be used.

One only of these copolymers may be used, or two or more of these copolymers may be used in combination. A copolymer in which a monomer having a carboxy group is not copolymerized, and a copolymer in which a monomer having a carboxy group is copolymerized may be used in combination.

Among them, the thickener is preferably a copolymer obtained by at least copolymerizing at least one monomer selected from the group consisting of ethylene, propylene, isoprene, and butadiene, and a (meth)acrylate, more preferably a copolymer obtained by at least copolymerizing at least one monomer selected from the group consisting of ethylene, propylene, isoprene, and butadiene, a (meth)acrylate, and a monomer having a carboxy group, from the viewpoint of the high moisture heat resistance and thermal shock resistance, heat resistance, and bending resistance of the obtained cured product.

One thickener may be used alone, or two or more thickeners may be used in combination.

The content of the thickener is preferably 0.1 parts by mass to 23 parts by mass, more preferably 1 part by mass to 12 parts by mass, and further preferably 2 parts by mass to 8 parts by mass with respect to 100 parts by mass in total of the 2-cyanoacrylate compound from the viewpoint of the moisture heat resistance, thermal shock resistance, heat resistance, and sealing properties of the obtained cured product.

### 3. (Meth)acrylate Having Two or More (Meth)acryloyloxy Groups in One Molecule

The composition for sealing a coated electric wire according to the present invention can contain a (meth)acrylate having two or more (meth)acryloyloxy groups in one molecule in order to provide heat resistance and flexibility to the obtained cured product.

As the (meth)acrylate having two or more (meth)acryloyloxy groups in one molecule, various ones can be used, but those containing no functional group such as an amino group that may adversely affect the stability of the composition and the adhesiveness of the 2-cyanoacrylate compound are preferred. The upper limit of the number of (meth)acryloyloxy groups in one molecule is not particularly limited and can be, for example, 6 or less.

Examples of (meth)acrylates having two (meth)acryloyloxy groups in one molecule include ethylene glycol di(meth)acrylate (examples of commercial products include NK Ester 1G (trade name, manufactured by Shin Nakamura Chemical Co., Ltd.), the same applies below), polyethylene glycol di(meth)acrylate (acrylate: ARONIX M-240 (trade name, manufactured by Toagosei Co., Ltd.) and the like, methacrylate: NK Ester 4G, 9G, 14G, and 23G (trade names, manufactured by Shin Nakamura Chemical Co., Ltd.) and the like), tripropylene glycol di(meth)acrylate (ARONIX M-220 (trade name, manufactured by Toagosei Co., Ltd.) and the like), neopentyl glycol di(meth)acrylate (Light Acrylate NP-A (trade name, manufactured by Kyoeisha Chemical Co., Ltd.) and the like), 1,6-hexanediol di(meth)acrylate (Light Acrylate 1.6HX-A (trade name, manufactured by Kyoeisha Chemical Co., Ltd.) and the like), the ethylene oxide-modified di(meth)acrylate of bisphenol A (ARONIX M-211B (trade name, manufactured by Toagosei Co., Ltd.) and the like), 3-(meth)acryloyloxyglycerin mono(meth)acrylate (Light Acrylate G-201P (trade name, manufactured by Kyoeisha Chemical Co., Ltd.) and the like), hydrogenated dicyclopentadienyl di(meth)acrylate (Light Acrylate DCP-A (trade name, manufactured by Kyoeisha Chemical Co., Ltd.) and the like), a polyester (meth)acrylate represented by the following formula (A) (KAYARAD HX-220 and 620 (trade names, manufactured by Nippon Kayaku Co., Ltd.) and the like), urethane (meth)acrylates (ARONIX M-1100 and 1200 (trade names, manufactured by Toagosei Co., Ltd.) and the like), and a bisphenol A-diepoxy-(meth)acrylic acid adduct (Viscoat#540 (trade name, manufactured by OSAKA ORGANIC CHEMICAL INDUSTRY LTD.) and the like).

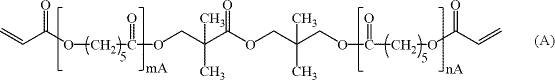

In the above formula (A), the average value of mA + nA is 2 to 4.

Examples of (meth)acrylates having three (meth)acryloyloxy groups in one molecule include pentaerythritol tri(meth)acrylate (ARONIX M-305 (trade name, manufactured by Toagosei Co., Ltd.) and the like), trimethylolpropane tri(meth)acrylate (ARONIX M-309 (trade name, manufactured by Toagosei Co., Ltd.) and the like), trimethylolpropane propylene oxide-modified tri(meth)acrylate (ARONIX M-321 (trade name, manufactured by Toagosei Co., Ltd.) and the like), and trimethylolpropane tri(meth)acrylate (NK Ester A-TMPT and TMPT (trade names, manufactured by Shin Nakamura Chemical Co., Ltd.) and the like).

(Meth)acrylates having four (meth)acryloyloxy groups in one molecule include pentaerythritol tetra(meth)acrylate (ARONIX M-450 (trade name, manufactured by Toagosei Co., Ltd.) and the like). Examples of (meth)acrylates having five (meth)acryloyloxy groups in one molecule include dipentaerythritol penta (meth) acrylate. Examples of (meth)acrylates having six (meth)acryloyloxy groups in one molecule include dipentaerythritol hexa(meth)acrylate (KAYARAD DPHA (trade name, manufactured by Nippon Kayaku Co., Ltd.)) and dipentaerythritol propylene oxide-modified hexa(meth)acrylate (KAYARAD DPCA-20, 30, 60, and 1209 (trade names, manufactured by Nippon Kayaku Co., Ltd.)).

One of these may be used alone, or two or more of these can also be used in combination.

Among these, the acrylate represented by the formula (A), polyethylene glycol di(meth)acrylate and/or polypropylene glycol di(meth)acrylate, and the like are preferably used because the obtained cured product has moderate flexibility.

The content of the (meth)acrylate having two or more (meth)acryloyloxy groups in one molecule is preferably 50 mass% or less, more preferably 3 mass% to 35 mass%, still more preferably 3 mass% to 25 mass%, and particularly preferably 3 mass% to 18 mass% with respect to the total mass of the composition for sealing a coated electric wire, from the viewpoint of the water resistance and thermal shock resistance of the obtained cured product.

### 4. Plasticizer

The composition for sealing a coated electric wire according to the present invention preferably further includes a plasticizer from the viewpoint of the moisture heat resistance and thermal shock resistance, heat resistance, and bending resistance of the obtained cured product.

When as the thickener, particularly a copolymer obtained by using many monomers that can form the poorly soluble polymer, that is, a copolymer having many poorly soluble segments (a copolymer in which the proportion of the poorly soluble segment is 65 mol % or more), is used, its solubility can be improved by containing an appropriate amount of the plasticizer.

Examples of the plasticizer include triethyl acetylcitrate, tributyl acetylcitrate, dimethyl adipate, diethyl adipate, dimethyl sebacate, dimethyl phthalate, diethyl phthalate, dibutyl phthalate, diisodecyl phthalate, dihexyl phthalate, diheptyl phthalate, dioctyl phthalate, bis(2-ethylhexyl) phthalate, diisononyl phthalate, diisotridecyl phthalate, dipentadecyl phthalate, dioctyl terephthalate, diisononyl isophthalate, decyl toluate, bis(2-ethylhexyl) camphorate, 2-ethylhexylcyclohexyl carboxylate, diisobutyl fumarate, diisobutyl maleate, caproic acid triglyceride, 2-ethylhexyl benzoate, and dipropylene glycol dibenzoate.

Among these, at least one compound selected from the group consisting of tributyl acetylcitrate, dimethyl adipate, dimethyl phthalate, 2-ethylhexyl benzoate, and dipropylene glycol dibenzoate is preferred in terms of good compatibility with the 2-cyanoacrylate compound and high plasticization efficiency.

One only plasticizer may be used, or two or more plasticizers may be used in combination.

The content of the plasticizer is not particularly limited but is preferably 0.01 parts by mass to 20 parts by mass, more preferably 0.01 parts by mass to 10 parts by mass, and particularly preferably 0.01 parts by mass to 7 parts by mass with respect to 100 parts by mass of the content of the 2-cyanoacrylate compound from the viewpoint of the moisture heat resistance and thermal shock resistance, heat resistance, and bending resistance of the obtained cured product.

### 5. Phthalic Anhydride Derivative Represented by Formula (1)

The composition for sealing a coated electric wire according to the present invention preferably further includes a phthalic anhydride derivative represented by the following formula (1) from the viewpoint of the high moisture heat resistance and thermal shock resistance, and heat resistance of the obtained cured product.

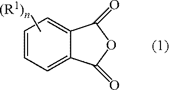

wherein R¹ each independently represents an alkyl group, an acyl group, an acyloxy group, an aryloxycarbonyl group, an aryl group, a hydroxy group, a chlorine atom, a bromine atom, or an iodine atom, and n represents an integer of 1 to 4.

R¹ in the formula (1) is each independently preferably an alkyl group having 1 to 4 carbon atoms, a chlorine atom, or a bromine atom, more preferably a methyl group or a bromine atom, from the viewpoint of the solubility in the 2-cyanoacrylate compound and the stability and curability of the composition.

n is preferably an integer of 1 to 3, more preferably 1 or 2, and particularly preferably 1.

Specific examples of the phthalic anhydride derivative represented by the formula (1) include 3-methylphthalic anhydride, 4-methylphthalic anhydride, 4-tert-butylphthalic anhydride, 3-hydroxyphthalic anhydride, 4-hydroxyphthalic anhydride, 3-acetoxyphthalic anhydride, 4-benzoylphthalic anhydride, 4-phenylphthalic anhydride, 4-phenoxycarbonylphthalic anhydride, 3-chlorophthalic anhydride, 4-chlorophthalic anhydride, 3-bromophthalic anhydride, 4-bromophthalic anhydride, 3-iodophthalic anhydride, 4-iodophthalic anhydride, 3,4-dichlorophthalic anhydride, 3,5-dichlorophthalic anhydride, 3,6-dichlorophthalic anhydride, 4,5-dichlorophthalic anhydride, 3,4-dibromophthalic anhydride, 3,5-dibromophthalic anhydride, 3,6-dibromophthalic anhydride, 4,5-dibromophthalic anhydride, 3,4-diiodophthalic anhydride, 3,5-diiodophthalic anhydride, 3,6-diiodophthalic anhydride, 4,5-diiodophthalic anhydride, 4-bromo-5-iodophthalic anhydride, 3,4,5-trichlorophthalic anhydride, 3,4,6-trichlorophthalic anhydride, 3,4,5-tribromophthalic anhydride, 3,4,6-tribromophthalic anhydride, 3,4,5-triiodophthalic anhydride, 3,4,6-triiodophthalic anhydride, tetrabromophthalic anhydride, tetrachlorophthalic anhydride, and tetraiodophthalic anhydride.

The content of the phthalic anhydride derivative represented by the formula (1) is preferably 0.01 mass% to 5 mass%, more preferably 0.05 mass% to 4 mass%, and particularly preferably 0.1 mass% to 3 mass% with respect to the total mass of the composition from the viewpoint of the moisture heat resistance and thermal shock resistance, and heat resistance of the obtained cured product.

### 6. Polymerization Initiator

The composition for sealing a coated electric wire according to the present invention may contain a polymerization initiator.

Particularly, in a mode in which the composition of the present invention contains the (meth)acrylate component having two or more (meth)acryloyloxy groups in one molecule, the composition preferably contains a radical polymerization initiator for accelerating the polymerization of the (meth)acrylate component.

Examples of the polymerization initiator preferably include thermal polymerization initiators, more preferably thermal radical polymerization initiators.

Examples of the radical polymerization initiators include organic peroxides such as hydroperoxides, peroxyesters, ketone peroxides, peroxyketals, dialkyl peroxides such as di-t-butyl hydroperoxide, diacyl peroxides, and peroxydicarbonates.

The content of the polymerization initiator is preferably 0.1 mass% to 1 mass%, more preferably 0.3 mass% to 0.6 mass%, with respect to the total mass of the composition of the present invention from the viewpoint of storage stability.

### 7. Curing Accelerator

The composition for sealing a coated electric wire according to the present invention may contain a curing accelerator for the 2-cyanoacrylate compound.

As the curing accelerator, various types of polymerization accelerators can be used, but anionic polymerization accelerators are preferred.

Examples of the anionic polymerization accelerators include polyalkylene oxides and derivatives thereof, crown ethers and derivatives thereof, silacrown ethers and derivatives thereof, and calixarene derivatives, and among these, crown ethers and calixarene derivatives are preferred.

When the curing accelerator is a crown ether and a calixarene derivative, their content is preferably 10 ppm or more and 30000 ppm or less with respect to the total mass of the composition of the present invention from the viewpoint of storage stability.

### 8. Other Components

The composition for sealing a coated electric wire according to the present invention may contain other components in addition to the above components. Examples of other components include known additives, specifically a stabilizer, a colorant, a polymerization retarder, a diluent, and a filler (silica particles and the like).

The content of other components is not particularly limited but is preferably 20 mass% or less, more preferably 10 mass% or less, with respect to the total mass of the composition of the present invention.

As the stabilizer, known polymerization retarders and polymerization inhibitors can be used, and examples thereof include hydroquinone and sulfurous acid gas.

Examples of the colorant include dyes and pigments, and those used for the coloration of coating materials for the electric wires of coated electric wires, for example, those described in Japanese Pat. Laid-Open No. 2016-011366, can be used.

### 9. Physical Properties of Composition for Sealing Coated Electric Wire

The composition for sealing a coated electric wire according to the present invention provides a cured product excellent in heat resistance, moisture heat resistance, and thermal shock resistance. These properties are specifically properties using as an indicator the suction length when a tip of a capillary tube having an inner diameter of 1.05 mm and a length of 120 mm is immersed in a bath solution of the composition for sealing a coated electric wire having a depth of 30 mm for 2 seconds and pulled up, and then the capillary tube is left to stand for 24 hours in a state in which the capillary tube is placed so that the longitudinal direction of the capillary tube is horizontal with respect to the gravity direction. It has been found that according to the present invention, when this suction length is 7 mm or more, the penetration properties and filling properties between the core wires of an electric wire are excellent, and when this suction length is 42 mm or less, the fluidity is moderately suppressed, and thus the retention properties between the core wires are excellent, and as a result, a composition for sealing a coated electric wire that is excellent in heat resistance, moisture heat resistance, and thermal shock resistance is obtained. In the present invention, this suction length is preferably 8 mm or more and 35 mm or less, more preferably 8 mm or more and 30 mm or less.

The composition for sealing a coated electric wire according to the present invention preferably has a viscosity of 12 to 120 mPa·s, more preferably 12 mPa·s or more and less than 100 mPa·s, at 25° C. When the viscosity is in this range, a composition for sealing a coated electric wire that is excellent in workability and sealing properties is obtained.

According to the present invention, the suction length and viscosity can be achieved by suitably selecting the respective types and blended amounts of the alkyl-2-cyanoacrylate having an alkyl group having 2 or more carbon atoms, the 2-cyanoacrylate having an ether bond in the ester residue, and the thickener from the ranges described above and blending them, and blending, as needed, at least one of the above-described other components in an amount suitably selected from the range described above.

### 10. Method of Use

The composition for sealing a coated electric wire according to the present invention can be used for various coated electric wires such as those in which one conducting wire is coated with an insulating coating, and those in which a twisted wire in which several conducting wires are twisted is coated with an insulating coating.

Specifically, by coating the exposed portion of a coated electric wire and the periphery thereof with the composition of the present invention, and curing the composition, the periphery of the exposed portion of the coated electric wire can be sealed.

As the coating method, various methods can be adopted, and examples thereof can include a method of applying or injecting the composition of the present invention to the exposed portion of a coated electric wire and the periphery thereof, or a method of immersing the exposed portion of a coated electric wire and the periphery thereof in the composition of the present invention.

As the method for curing the composition of the present invention coating the exposed portion of the coated electric wire and the periphery thereof, methods usually adopted for cyanoacrylate-based adhesives can be applied. Usually, the composition cures by the moisture in the air by standing, and when the curing rate is not sufficient, an anionic polymerization initiator, an amine, for example, N,N′-dimethylaniline or triethanolamine (commercial products include aa Accelerator (manufactured by Toagosei Co., Ltd.)], can also be sprayed on the coated portion to accelerate the curing.

The composition of the present invention is preferably prepared so as to have a viscosity at which this can easily penetrate the gap between a conducting wire and a coating to sufficiently seal the coated electric wire. The composition of the present invention preferably has such a viscosity because of excellent workability and also in that a method of immersing the exposed portion of a coated electric wire and the periphery thereof in the composition can be adopted.

More specifically, a conducting wire obtained by peeling off the coating of a coated electric wire is crimped with a particular component, and the exposed portion of this coated electric wire and the periphery thereof are immersed in the composition of the present invention. The time during which the exposed portion of the coated electric wire and the periphery thereof are immersed should be appropriately selected according to the type of the composition used but is usually about several seconds to 30 seconds.

This curing rate can be adjusted by adjusting the blending proportions of the above-described curing accelerator, polymerization retarder, and the like.

### 11. Coated Electric Wire

The coated electric wire of the present invention is a coated electric wire including a cured product of the composition for sealing a coated electric wire according to the present invention, preferably a coated electric wire sealed with a cured product of the composition for sealing a coated electric wire according to the present invention.

The composition for sealing a coated electric wire according to the present invention can be preferably used for sealing a portion where an electric wire is exposed, in a coated electric wire, particularly an end, splice portion, or the like of a coated electric wire, and can be more preferably used for sealing an electric wire exposed portion electrically connecting two or more coated electric wires.

The electric wire exposed portion may be an end or intermediate portion of a coated electric wire.

The composition for sealing a coated electric wire according to the present invention can also be preferably used for sealing in a connection portion between a coated electric wire and another member (a connector, a terminal, a protective tool, a forming tool, a fixture, a substrate, or the like).

The electric wire in the coated electric wire is not particularly limited, and known electric wires can be used. Examples of the material of the electric wire include copper, aluminum, and alloys thereof.

The electric wire may be a single wire or a plurality of wires but is preferably a plurality of wires.

The coating material in the coated electric wire is not particularly limited, and known coating materials can be used.

The coating material is preferably an insulating material.

The coating material preferably includes a resin, more preferably a thermoplastic resin.

The cross-sectional shape, length, coating thickness, and the like of the coated electric wire are not particularly limited and can be appropriately selected.

The coated electric wire of the present invention is not particularly limited, and examples thereof preferably include wire harnesses for automobiles, home electric appliances, OA equipment, and the like, particularly preferably wire harnesses for automobiles.

### EXAMPLES

The present invention will be specifically described below based on Examples. The present invention is not limited by these Examples. In the following, “parts” and “%” mean “parts by mass” and “mass%” respectively unless otherwise noted.

### Method for Measuring Viscosity at 25° C.

The viscosity of a composition for sealing a coated electric wire was measured under the following conditions using a TVE-20H type viscometer (salt water/plate type, manufactured by TOKI SANGYO CO., LTD.), which is an E-type viscometer (cone-plate type viscometer).

### Measurement Conditions

Cone shape: angle 1° 34′, radius 24 mm
Temperature: 25° C. ± 0.5° C.

### Method for Measuring Suction Length

The suction length of a composition for sealing a coated electric wire was obtained by measuring the suction length when a tip of a capillary tube having an inner diameter of 1.05 mm and a length of 120 mm was immersed in a bath solution of 30 mm in depth of the composition for sealing a coated electric wire for 2 seconds and pulled up, and then the capillary tube was left to stand for 24 hours in a state in which the capillary tube was placed so that the longitudinal direction of the capillary tube was horizontal with respect to the gravity direction.

The measurement of the suction length was performed at 23° C. ± 0.5° C., and for the capillary tube, one made of borosilicate glass was used.

### Examples 1 to 17 and Comparative Examples 1 to 4

Components shown in Table 1 were mixed in a blending proportion shown in Table 1 by an ordinary method to prepare a composition for sealing a coated electric wire.

### Evaluation

For the obtained compositions for sealing coated electric wires, the viscosity and the suction length were measured according to the above measurement methods, and the following evaluation was performed. Their results are shown in Table 2.

### Electric Wire Sealing Property Test (Moisture Heat Test, Thermal Shock Test, and Heat Resistance Test)

The coating polyvinyl chloride of a soft polyvinyl chloride-coated conducting wire (the diameter of the conducting wire: the diameter of one in which 30 copper wires were twisted: 2.5 mm, the outer diameter of the coating polyvinyl chloride: 3.5 mm) was peeled off by 15 mm from a tip, and 30 mm of the coated conducting wire from the tip was immersed in a composition for sealing a coated electric wire for about 2 seconds, followed by aging under an atmosphere at 23° C. and a humidity of 50% for 1 or more days for curing.

For the sealed coated electric wire exposed to a moisture heat environment at 80° C. and a humidity of 95% RH for 50 hours, an electric wire sealing property test was performed (moisture heat test).

On the other hand, also for the sealed coated electric wire subjected to 100 cycles of thermal shock at -40° C. for 30 minutes to 120° C. for 30 minutes, the electric wire sealing property test was performed in the same manner as above (thermal shock test).

Further, also for the sealed coated electric wire exposed to 120° C. for 96 hours, the electric wire sealing property test was performed in the same manner as above (heat resistance test).

In the electric wire sealing property test, compressed air at the predetermined pressures shown below was fed from the side of the coated electric wire not subjected to sealing treatment, and the tip of the coated electric wire was immersed in water to confirm the presence or absence of air leakage.

An evaluation was made by A to E according to the airtight pressure at which air leakage occurred.
A: an airtight pressure of 0.5 kg/cm² or more
B: an airtight pressure of 0.3 kg/cm² or more and less than 0.5 kg/cm²
C: an airtight pressure of 0.1 kg/cm² or more and less than 0.3 kg/cm²
D: an airtight pressure of less than 0.1 kg/cm²

TABLE 1

Composition (parts by mass)

| | Cyanoacrylate | | | | | | | | (Meth)acrylate | | Thickener | | Polymerizat ion initiator | Plasticizer | Additive | Curing accelerator | |
|---|---|---|---|---|---|---|---|---|---|---|---|---|---|---|---|---|---|
| | Ethyl-2-cyanoacr ylate | Normal-propyl-2-cyanoacr ylate | Isopropyl -2-cyanoacr ylate | sec-Butyl-2-cyanoacr ylate | Normal-butyl-2-cyanoacr ylate | Normal-hexyl-2-cyanoacr ylate | Ethoxyet hyl-2-cyanoacr ylate | 2-Octyl-2-cyanoacr ylate | KAYARAD HX-620 | M-321 | Vamac G | PANDEX T5201 | PERBUTYL Z (ppm) | ATBC | 4-MePA (ppm) | Dibenzo-18-crown-6-ether (ppm) | CALIX B4-EA (ppm) |
| Example 1 | 10 | | | | | | 90 | | 20 | | 4 | | 5000 | | 2500 | | 2000 |
| Example 2 | 15 | | | | | | 85 | | 20 | | 5 | | 5000 | | 2500 | | |
| Example 3 | 40 | | | | | | 60 | | 10 | | 5 | | 5000 | | 2500 | | 2000 |
| Example 4 | 10 | | | | | | 90 | | 10 | | | 14 | 5000 | | 2500 | 2000 | |
| Example 5 | 20 | | | | | | 80 | | 10 | | | 22 | 5000 | | 2500 | 2000 | |
| Example 6 | 20 | | | | | | 60 | 20 | 25 | | 2.5 | | 5000 | | | | |
| Example 7 | | 20 | | | | | 80 | | 15 | | 3 | | 5000 | | 2500 | 2000 | |
| Example 8 | | 40 | | | | | 60 | | 15 | | 5 | | 5000 | | 2500 | 2000 | |
| Example 9 | | | 20 | | | | 80 | | | 10 | 1 | | 5000 | | 2500 | | |
| Example 10 | | | 40 | | | | 60 | | | 10 | 6 | | 5000 | | 2500 | 2000 | |
| Example 11 | | | 80 | | | | 20 | | | | 2 | | | 1 | 2500 | | |
| Example 12 | | | 90 | | | | 10 | | | | 7 | | | 7 | 2500 | | |
| Example 13 | | | | 20 | | | 80 | | 10 | | 5 | | 5000 | | 2500 | | |
| Example 14 | | | | | 10 | | 90 | | 20 | | 3 | | 5000 | | 2500 | 2000 | |
| Example 15 | | | | | 50 | | 50 | | | 5 | 4 | | 5000 | | 2500 | | 2000 |
| Example 16 | | | | | | 35 | 65 | | 10 | | 3 | | 5000 | | 2500 | 2000 | |
| Example 17 | | | | | | 45 | 55 | | 40 | | 5 | | 5000 | | 2500 | | |
| Comparative Example 1 | 40 | | | | | | 60 | | | | | | | | | | |
| Comparative Example 2 | 80 | | | | | | 20 | | | | | | | | | | |
| Comparative Example 3 | 90 | | | | | | 10 | | 2 | | | | 3000 | | 5000 | 2000 | |
| Comparative Example 4 | | | 90 | | | | 10 | | | | 25 | 25 | | | | | |

The details of the following terms in Table 1 are shown below.
KAYARAD HX-620: a trade name of the acrylate compound represented by the formula (A), wherein mA + nA = 4, manufactured by Nippon Kayaku Co., Ltd.
M-321: ARONIX M-321 (trade name) (trimethylolpropane propylene oxide-modified tri(meth)acrylate) manufactured by Toagosei Co., Ltd.
Vamac G: a trade name of an ethylene acrylic elastomer (ethylene-methyl acrylate-acrylic acid copolymer), manufactured by Du Pont, Mw = 260000, the peak temperature of the loss tangent (tan δ) measured at a frequency of 1 Hz is -21.3° C.
PANDEX T5201: a trade name of a polyurethane copolymer, manufactured by DIC CORPORATION, Mw = 100000, the peak temperature of the loss tangent (tan δ) measured at a frequency of 1 Hz is -110° C.
PERBUTYL Z: a trade name of di-t-butyl hydroperoxide, manufactured by NOF CORPORATION
ATBC: tributyl acetylcitrate, manufactured by TOKYO CHEMICAL INDUSTRY CO., LTD.
4-MePA: 4-methylphthalic anhydride, manufactured by TOKYO CHEMICAL INDUSTRY CO., LTD.
CALIXB4-EA: a trade name of tetraethyl 4-t-butylcalix[4]arene-tetraacetate, manufactured by SUGAI CHEMICAL IND. CO., LTD.

TABLE 2

| | Suction length (mm) | Viscosity (mPa · s) | Moisture heat test | Thermal shock test | Heat resistance test |
|---|---|---|---|---|---|
| Example 1 | 15 | 57 | B | A | A |
| Example 2 | 18 | 55 | A | A | A |
| Example 3 | 15 | 52 | A | A | A |
| Example 4 | 16 | 54 | B | A | A |
| Example 5 | 8 | 118 | B | A | A |
| Example 6 | 24 | 30 | B | A | A |
| Example 7 | 19 | 35 | A | A | A |
| Example 8 | 14 | 62 | A | A | A |
| Example 9 | 40 | 15 | B | B | A |
| Example 10 | 17 | 78 | A | A | A |
| Example 11 | 28 | 28 | A | B | A |
| Example 12 | 9 | 108 | A | A | A |
| Example 13 | 14 | 59 | A | B | A |
| Example 14 | 18 | 39 | A | B | A |
| Example 15 | 17 | 41 | A | A | A |
| Example 16 | 20 | 32 | A | A | A |
| Example 17 | 11 | 68 | A | A | B |
| Comparative Example 1 | 45 | 10 | C | D | C |
| Comparative Example 2 | 48 | 8 | D | D | C |
| Comparative Example 3 | 50 | 7 | D | D | C |
| Comparative Example 4 | 2 | 1258 | D | D | D |

As shown in Table 2, the compositions for sealing coated electric wires in Examples 1 to 17 have moderate suction length and viscosity, and the obtained cured products are excellent in moisture heat resistance, thermal shock resistance, and heat resistance, compared with the compositions in Comparative Examples 1 to 4.

### INDUSTRIAL APPLICABILITY

The composition for sealing a coated electric wire according to the present invention is excellent in workability, and its cured product is excellent in heat resistance, moisture heat resistance, and thermal shock resistance and has good electric wire sealing properties, and therefore the composition can be widely utilized as an electric wire sealing agent for the wiring of the various types of electrical systems of automobiles, home electric appliances, OA equipment, and the like, and various types of outdoor and indoor wiring.

This application claims priority to Japanese Pat. Application No. 2020-119517 filed Jul. 10, 2020, the entire disclosure of which is incorporated herein.

1. A composition for sealing a coated electric wire, which comprises
a 2-cyanoacrylate compound comprising an alkyl-2-cyanoacrylate having an alkyl group with 2 or more carbon atoms, and a 2-cyanoacrylate having an ether bond in an ester residue thereof, and
a thickener,
wherein the composition comprises 10 mass% or more of the 2-cyanoacrylate having an ether bond in an ester residue thereof relative to 100 mass% of the total of the 2-cyanoacrylate compound,
said composition exhibiting a suction length of not less than 7 mm to not more than 42 mm when a tip of a capillary tube having an inner diameter of 1.05 mm and a length of 120 mm is immersed in a bath solution of 30 mm in depth of the composition for sealing a coated electric wire for 2 seconds and pulled up, and then the capillary tube is left to stand for 24 hours in a state in which the capillary tube is placed so that a longitudinal direction of the capillary tube is horizontal with respect to a gravity direction.

2. The composition for sealing a coated electric wire according to claim 1, having a viscosity of 12 to 120 mPa·s at 25° C.

3. The composition for sealing a coated electric wire according to claim 1, wherein a content of the thickener is 0.1 parts by mass to 23 parts by mass relative to 100 parts by mass of the total of the 2-cyanoacrylate compound.

4. The composition for sealing a coated electric wire according to claim 1, wherein the thickener is a copolymer comprising a constituent unit derived from a (meth)acrylic monomer.

5. The composition for sealing a coated electric wire according to claim 1, wherein the thickener is an elastomer.

6. The composition for sealing a coated electric wire according to claim 1, wherein a weight average molecular weight of the thickener is 50000 or more.

7. The composition for sealing a coated electric wire according to claim 1, wherein the alkyl-2-cyanoacrylate having an alkyl group with 2 or more carbon atoms is at least one selected from a group consisting of ethyl-2-cyanoacrylate, n-propyl-2-cyanoacrylate, isopropyl-2-cyanoacrylate, n-butyl-2-cyanoacrylate, sec-butyl-2-cyanoacrylate, isobutyl-2-cyanoacrylate, and n-hexyl-2-cyanoacrylate.

8. The composition for sealing a coated electric wire according to claim 1, wherein a blending proportion of the alkyl-2-cyanoacrylate having an alkyl group with 2 or more carbon atoms is not less than 10 mass% to not more than 90 mass% relative to 100 mass% of the total of the 2-cyanoacrylate compound.

9. The composition for sealing a coated electric wire according to claim 1, wherein the thickener is a copolymer comprising at least a constituent unit derived from at least one monomer selected from a group consisting of ethylene, propylene, isoprene and butadiene, and a constituent unit derived from a (meth)acrylate.

10. The composition for sealing a coated electric wire according to claim 1, wherein the thickener is a copolymer comprising at least a constituent unit derived from at least one monomer selected from a group consisting of ethylene, propylene, isoprene and butadiene, a constituent unit derived from a (meth)acrylate, and a constituent unit derived from a monomer having a carboxy group.

11. The composition for sealing a coated electric wire according to claim 1, comprising 0 to 50 mass% of a (meth)acrylate having two or more (meth)acryloyloxy groups in one molecule relative to 100 mass% of the total of the composition.

12. The composition for sealing a coated electric wire according to claim 1, further comprising a phthalic anhydride derivative represented by the following general formula (1): 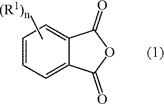
wherein R¹ is each independently an alkyl group, an acyl group, an acyloxy group, an aryloxycarbonyl group, an aryl group, a hydroxy group, a chlorine atom, a bromine atom, or an iodine atom, and n is an integer of 1 to 4.

13. The composition for sealing a coated electric wire according to claim 1, further comprising a plasticizer.

14. The composition for sealing a coated electric wire according to claim 13, wherein a content of the plasticizer is 1 to 10 parts by mass relative to 100 parts by mass of the total of the 2-cyanoacrylate compound.

15. A coated electric wire comprising a cured product of the composition for sealing a coated electric wire according to claim 1.

16. A method for making a sealed coated electric wire, comprising coating an exposed portion of a coated electric wire and a periphery thereof with the composition for sealing a coated electric wire according to claim 1, and curing the composition.
